(19) United States
(12) Patent Application Publication
(10) Pub. No.: US 2008/0178613 A1
(43) Pub. Date: Jul. 31, 2008

(54) System and method for impingement cooling

(76) Inventor: Lloyd H. Smith, College Station, TX (US)

Correspondence Address: DOCKET CLERK, P.O. DRAWER 800889, DALLAS, TX, 75380, US

(21) Appl. No.: 12/008,993

(22) Filed: Jan. 14, 2008

Related U.S. Application Data
(60) Provisional application No. 60/880,207, filed on Jan. 12, 2007.
(60) Provisional application No. 60/903,453, filed on Feb. 26, 2007.

(51) Int. Cl. F25D 25/00; F28D 5/00; F25D 25/04; G05D 23/00

(52) U.S. Cl. 62/62; 62/314; 62/380; 700/300

(57) ABSTRACT

A system and method of impingement cooling are presented. A cooling apparatus for cooling food product containers to a predetermined temperature includes a thermal treatment apparatus and a container support apparatus. The thermal treatment apparatus includes an air duct, a plurality of plenums coupled to the air duct, and a fan. The air duct is adapted to receive air from a first area where food products are kept at a temperature below the predetermined temperature. The plenums have orifices and the fan is adapted to push air received from the first area into the plurality of plenums. The container support apparatus includes a plurality of container supports adapted to support food product containers. The container support apparatus is positioned to interleave the food product containers with the plurality of plenums. Air discharged through the orifices impinges on food product containers supported by the container support apparatus.

### CROSS-REFERENCE TO RELATED APPLICATIONS

This application claims priority to Provisional U.S. Patent Application Ser. No. 60/880,207, filed Jan. 12, 2007, and entitled “IMPINGEMENT COOLING DEVICE” and Provisional U.S. Patent Application Ser. No. 60/903,453, filed Feb. 26, 2007, and entitled “IMPINGEMENT COOLING DEVICE.” The above Provisional U.S. patent applications are incorporated herein by reference for all purposes as if fully set forth herein.

### BACKGROUND

The disclosure relates in general to the field of refrigeration and specifically to a system and method for impingement cooling.

### DESCRIPTION OF THE RELATED ART

U.S. Pat. No. 4,154,861, titled “Heat Treatment of Food Products”; U.S. Pat. No. 4,474,498, titled “Multiple-Pass Impingement Heating and Cooling Device”; U.S. Pat. No. 4,479,776, “Thermal Treatment of Food Products”; and U.S. Pat. No. 4,523,391, titled “High Efficiency Impingement Heating and Cooling Apparatus” deal with thermally treating food products by impingement heating or cooling. Food on a conveyor is moved between the tapered ducts which direct high velocity streams of temperature controlled gas toward the moving product, thus transferring thermal energy either into or out of food products.

Cooling of processed product is important in many industries. In food service operations cooling of cooked or otherwise processed food is an essential deterrent to the growth of microorganisms which can cause food poisoning. The Food and Drug Administration Model Food Code and The United States Department of Agriculture Food and Nutrition Services have established guidelines for protection of hazardous foods by keeping them out of the danger zone between 41° F. and 135° F. The USDA cooling guidelines requires that food being cooled from 140° F. must reach a temperature of 70° F. within two hours of time that the cooling process started and to 41° F. within an additional four hours. This rate of cooling has been adapted as a requirement for the Uniform Health Code used by most of Health Departments in the United States as a means of protecting the public from food borne illness. The object of these regulations is to bring the core temperature of the food down through the danger zone (140° F. to 41° F.) quickly to inhibit rapid bacteria growth.

Commercially available refrigerated and frozen food cabinet or walk-in vaults have been used for years in the food service industry to cool processed foods and hold the food at temperatures that are considered safe from significant bacterial growth. These conventional cooling devices are capable of holding food at a safe temperature and to cool a predetermined amount of food from the safe hot holding temperature to refrigerated temperature in an extend period of time. Published scientific tests (Sandra J. Ley, R. D., “Cooling Times,” Table 2.2, p. 24. Food-Service Refrigeration CBI Publishing Co. Inc. (Boston: 1980)) reported that food at 140° F. placed in a 38° F. holding refrigerator in 2″ deep pans requires as much as 13 hours to reach the recommended food holding temperature of 41° F. This extended time to cool food is a result of low air velocity across the food containers, insufficient cooling capacity and the lack of stirring or agitation of the food product to mix the cooler outer layer and the warm inner layers.

Cooling of food or any other substance requires a sufficient quantity of cooling fluid, movement of the cooling fluid around the warm object, and the transfer of heat out of the object being cooled through conduction, convection, evaporative cooling or other means. Cooling of food is often slowed by the nature of the food which is not a homogenous mixture. For example, soups can contain numerous different ingredients that resist cooling based on their structure and fiber content. As a soup remains in a container the solids ingredients settle to the bottom and form a layer that resists convection currents which aid in the cooling process. As cooling continues the gelatinized starches begin to thicken further reducing cooling through natural convection currents.

Foods undergoing the cooling process are placed within a container, usually a rectangular or cylinder shaped pan or a sealed bag. Blast chillers are typically constructed using rectangular chambers in-which the food is placed inside the unit using pan slides or rolled in on a rack. The chambers are cooled using refrigeration compressors and coils designed to rapidly remove thermal energy from the space with a fairly high velocity air flow moving horizontally through the blast chiller system in relation to the containers of food. This high velocity air provides heat transfer on the leading edge of the food container and reduced amounts on the sides and back of the container as the air flows around the container. Attempts to have the air contact additional portions of the container required sophisticated air controls and can result in turbulent air flow which contacts even less of the container.

These blast chillers use relatively large refrigeration compressors and evaporators and some actually use a large cooling compressor evaporator combination and a second smaller compressor for holding the food product after it has been cooled. Control systems used on the chillers are complex in order to control the temperature of the evaporator coil and air out of the evaporator coil. Some of the blast chiller units begin the cooling cycle with evaporator settings to produce air temperatures below freezing to increase the cooling rate. The evaporator temperatures are then warmed as cooling proceeds to prevent freezing of the foods. The process of varying the air temperature from the evaporator coils requires sophisticated control systems and the addition of a second compressor and evaporator coil increases the initial cost of the blast chiller system. Many of the blast chillers are self contained systems that contribute noise from the large compressors and addition heat load to the kitchens which must be removed by the building Heating, Ventilation and Air Conditioning (HVAC) systems.

The use of impingement heating and cooling devices as an apparatus for thermally treating food products has previously been disclosed. Heat transfer rates by impingement air devices has been reported by the inventor to be 2-10 times faster that the same volume of air moving parallel to the products surface. Such devices employ columnated jets of temperature controlled gas which impinges against the surface of a food product moving past the air columns. The devices are disclosed, for example, in U.S. Pat. Nos. 3,884,213; 4,154,861; 4,289,792; 4,474,498; 4,479,776; and 4,523,391. Tests of impingement device from U.S. Pat. No. 4,474,498 showed that hamburger patties could be frozen using −10° F. air at almost the same rate as a CO² tunnel freezer which utilizes liquid CO². Food prepared at 170° F. and packaged in casing bags was cooled in a system test by impingement air system using a 5° F. air source in less than 1.5 hours. This is a similar rate of cooling as a commercially available tumbling ice bath casing cooler.

It is a common practice in the food industry to rely on the available reach-in cabinets and walk-in refrigerators to cool prepared food even though the rate of cooling does not meet Federal guidelines. Available blast chillers are expensive in relation to reach-in and walk-in refrigerators. The rate of cooling of conventional refrigerators and walk-in coolers is limited by the low air velocity produced by the evaporator coil fans. The evaporator fans are designed to cool the space as a temperature holding device and not a rapid cooling device. Conventional refrigeration capacity is sufficient over time to reduce the temperature of a given volume of food as shown by Sandra J. Ley (“Cooling Times,” Table 2.2, p. 24. Food-Service Refrigeration CBI Publishing Co. Inc. (Boston: 1980)) studies but does not meet the federal standards.

The normal practice for cooling of foods is to place them in a shallow pan in the refrigerator with a cover over the pans opening. Stirring of liquid products to promote cooling is recommended but seldom accomplished.

### SUMMARY

In one embodiment of the present disclosure, a method of cooling food product containers to a predetermined temperature includes drawing air from a first area where food products are kept at a temperature below the predetermined temperature into a second area. The second area is separated from the first area. The method further includes pushing the air into a plurality of plenums having orifices, where the plenums are interleaved with a corresponding plurality of food product containers in the second area. The air discharged through the orifices impinges on the food product containers. The method also includes returning air from the second area to the first area.

In another embodiment of the disclosure a cooling apparatus for cooling food product containers to a predetermined temperature includes a thermal treatment apparatus and a container support apparatus. The thermal treatment apparatus includes an air duct, a plurality of plenums coupled to the air duct, and a fan. The air duct is adapted to receive air from a first area where food products are kept at a temperature below the predetermined temperature. The plenums have orifices and the fan is adapted to push air received from the first area into the plurality of plenums. The container support apparatus includes a plurality of container supports adapted to support food product containers. The container support apparatus is positioned to interleave the food product containers with the plurality of plenums. Air discharged through the orifices impinges on food product containers supported by the container support apparatus.

In yet another embodiment of the disclosure, a system for cooling food product containers to a predetermined temperature includes a first enclosed area where food products are kept at a temperature below the predetermined temperature. The system also includes a second enclosed area, separate from the first enclosed area. The system further includes a thermal treatment apparatus and a container support apparatus, both located in the second enclosed area. The thermal treatment apparatus includes an air duct, a plurality of plenums coupled to the air duct, and a fan. The air duct is adapted to receive air from the first enclosed area. The plenums have orifices and the fan is adapted to push air received from the first enclosed area into the plurality of plenums. The container support apparatus includes a plurality of container supports adapted to support food product containers. The container support apparatus is positioned to interleave the food product containers with the plurality of plenums. Air discharged through the orifices impinges on food product containers supported by the container support apparatus.

In another embodiment of the disclosure, a cooling apparatus for cooling food product containers to a predetermined temperature includes a source of air at a temperature below the predetermined temperature, a thermal treatment apparatus, a container support apparatus, and a motor. The thermal treatment apparatus includes a plurality of plenums and a fan that pushes air from the source of air into the plurality of plenums. The container support apparatus includes a plurality of container supports that support food product containers. The container support apparatus is positioned to interleave the food product containers with the plurality of plenums. Air discharged through the orifices impinges on food product containers supported by the container support apparatus. The motor moves the container support apparatus to cause circulation of a liquid in the food storage containers.

Other technical features may be readily apparent to one skilled in the art from the following figures, descriptions, and claims.

### BRIEF DESCRIPTION OF THE DRAWINGS

FIG. 1 depicts an oblique view of a thermal treatment apparatus according to the disclosure;

FIG. 2 illustrates a system utilizing a thermal treatment apparatus according to the disclosure;

FIG. 3 depicts a side elevation of a product cart for use with a thermal treatment apparatus according to the disclosure;

FIG. 4 presents a front elevation of the product cart of FIG. 3 engaged with a thermal treatment apparatus according to the disclosure;

FIG. 5 shows a side elevation of an air flow through a thermal treatment apparatus according to the disclosure;

FIG. 6 depicts a side elevation of another product cart for use with a thermal treatment apparatus according to the disclosure;

FIG. 7 presents a side elevation of the product cart of FIG. 6 engaged with a thermal treatment apparatus according to the disclosure;

FIG. 8 shows a side elevation of a product cart engaged with another thermal treatment apparatus according to the disclosure;

FIG. 9 depicts a front elevation of a product cart engaged with yet another thermal treatment apparatus according to the disclosure;

FIG. 10 presents an oblique view of a conveyor thermal treatment apparatus according to the disclosure;

FIG. 11 shows an oblique view of a thermal treatment apparatus built into a cabinet style refrigerated box; and

FIG. 12 depicts a schematic view of a monitoring system according to the disclosure.

### DETAILED DESCRIPTION

Embodiments of the disclosure provide a rapid cooling or blast chiller utilizing a small portion of a walk-in cooler and to utilize spare refrigeration capacity of both the cooler and freezer. Such embodiments may further reduce energy cost by efficiently utilizing the refrigeration capacity of two sources instead of adding completely new and independent refrigeration systems which may add additional heat load to hot kitchens.

Aspects of the disclosure may be found in cooling of food by agitating the food or product causing the liquid and suspended particles in the liquid to circulate past the exterior surfaces of the container being cooled and then to mix with warmer particles throughout the mixture. The columns of high velocity air impinge on the exterior top and bottom surfaces of the food or other product, transferring thermal energy to the surface of the product. Agitation of the liquid moves the cold liquid nearest to the cooler exterior throughout the container of food and in the process transfers cold thermal energy through the liquid.

Further aspects of the disclosure relate to utilizing a thermal storage mass of a cooling vault or cabinet, adjacent freezer vault or thermal storage system to supplement peak demand for thermal energy during a cooling cycle. Refrigerated storage facilities are designed to accommodate a significant mass of stored food and to maintain this food at a set temperature even when warm air is introduced by opening and closing of the vault doors and the addition of a certain amount of food at a warmer temperature than the vault. Studies of the time required to cool hot food to a safe storage temperature of 41° F. in a walk-in cooler vault or reach-in refrigerator reveal cooling times as high as 13 hours rather than the recommended 6 hours.

Reducing the cooling time to 6 hours or less in conventional cabinet refrigerators or walk-in coolers may require more cooling capacity than the refrigeration system can provide. The stored refrigerated food and vault temperature may rise above the recommended 41° F., reducing the shelf life of the stored food. Frozen food product, and the mass of construction materials in a freezer storage area such as metal shelving, evaporative condensers, concrete or metal floor and the metal vault skin may absorb cold thermal energy and then provide the thermal treatment apparatus with thermal energy when peak loads of hot food or product are introduced into the cooling apparatus. Cooling warm food with stored thermal energy may include a cycle that allows the conventional refrigeration system to run at peak capacity for a sufficient time to reduce the surround mass to a predetermined cold temperature. A freezer vault containing frozen food and equipment with a temperature of −10° F. can provide cooling energy to a mass of warm food by transferring thermal energy from the cold mass to the hot mass. A temporary 15° F. rise in the freezer mass may not harm the quality of the frozen food while contributing cooling capacity for the warm food. When the warm food is cooled the freezer space and its mass may be returned to the preferred holding temperature by extending the refrigeration system run time.

Still further aspects of the disclosure may be found in combining the cooling capacity of adjacent refrigerated spaces to supplement the refrigeration capacity of a unit cooling food or other products. Adjacent refrigerated spaces, especially units designed as freezer compartment, may provide supplemental cooling capacity from the freezer compressor and evaporator. Additional cooling capacity occurs when a transfer of cold thermal energy is greater than the capacity of a freezer refrigeration system. The freezer vault and its contents begin to transfer their cold energy to the cooling apparatus and the temperature in the freezer vault rises. Freezer refrigeration systems become more efficient as the surrounding temperature increases. This may provide additional cooling capacity that may be used to cool the hot food.

Other aspects of the disclosure may be found in a set of devices that allows cold air to be drawn through a heated air valve into an air duct that leads to a thermal treatment apparatus used to direct columnated jets of temperature-controlled gas at a high velocity on at least one surface of the food container or other product. A second heated valve allows the warmer air to return to the freezer compartment where it is mixed and cooled within that chamber.

Still other aspects of the disclosure may be found in the use of two variable speed fans to control the temperature of columnated jets of air. The transfer fan draws cold air from the freezer compartment which is ducted to the top of the cooling device. A second fan draws air from the refrigerated room and combines it with air from the freezer compartment. Yet other aspects of the disclosure may be found in a system using a single fan to draw cold air from both the freezer compartment and the refrigerated room and using two dampers to control the amount of air from each source.

Further aspects of the disclosure may be found in positioning temperature monitoring devices to monitor the rate of product cooling, the vault air temperature, and cooling gas temperatures in order to document cooling at a required rate and to maintain vault temperatures according to federally established guidelines for holding food. A control system may regulate an amount of cooling borrowed from adjacent refrigeration systems and thermal storage to prevent vaults from becoming too warm.

An impingement cooling apparatus is provided that is adapted to deliver a temperature controlled gas through a common air duct to a plurality of thermal treatment apparatus plenums adapted to direct columnated jets of the temperature-controlled gas so as to impinge against the upper and lower surfaces of food product or the containers holding the food product. One or more thermal treatment zones are contained within a single cabinet or enclosure so as to subject one or several different kinds of food products moving or stationary within the treatment zones to columns of high velocity fluid directed perpendicular to the product being cooled. These high velocity columns of fluid provide high thermal energy transfer rates.

An apparatus is provided that holds and positions food in any type of food safe container. This apparatus can accommodate one container or multiple containers positioned in horizontal and vertical relationship to each other. This apparatus may be fixed in one position or it may be mobile and suitable for moving food throughout the kitchen production and cooking systems. This apparatus may also be a conveyor or a system of conveyors to move the product through the thermal treatment zones.

A thermal treatment apparatus is provided that utilizes a common air duct which is connected to a plurality of thermal treatment apparatus plenums or jet fingers to deliver temperature-controlled gas from a common air duct to at least two thermal zones that impinge on the food products contained in the holding rack. The ducts are preferably adapted to cause columnated jets of temperature controlled gas to impinge on at least one surface of the food products or their containers.

Aspects of the disclosure may be found in an impingement cooling apparatus located with a cabinet or vault that has a conventional refrigeration system or cryogenic cooling system capable of holding food at a safe temperature and to cool a predetermined amount of food from safe hot holding temperature to safe refrigerated temperature in an extend period of time. These cabinets or vaults are, recognized in the food service industry as refrigerator or freezer cabinets and walk-in coolers. These devices are designed to hold food at temperatures equal or less than 41° F. The impingement cooling apparatus obtains part or all of its thermal cooling energy from the containing vault.

Aspects of the disclosure may be found in an impingement cooling apparatus located with a cabinet or vault specifically designed to house the apparatus. Refrigeration systems may be incorporated as part of this cabinet or vault or may be delivered from a remote location as a ducted air flow.

Other aspects of the disclosure may be found in an impingement cooling apparatus capable of cooling a defined amount of food product from safe hot holding temperatures to 41° F. in compliance with USDA and FDA recommendations.

Yet other aspects of the disclosure may be found in an impingement cooling apparatus that captures additional cooling capacity of an adjacent refrigeration system. By combining the excess refrigeration capacity of two or more vaults the total cooling capacity for quick chilling is increased.

Further aspects of the disclosure may be found in an impingement cooling apparatus that utilizes the thermal storage capacity of a freezer vault or other thermal storage system to provide thermal cooling for a cyclical cooling process. A freezer vault designed for −10° F. storage capacity can act as a thermal storage device by utilizing the cold thermal energy captured in the mass of the vault, product and equipment to cool the hot food by changing the mass temperature by an arbitrary amount such as −10° F. to 5° F. Circulating cold air from the freezer to the thermal treatment apparatus and then returning the warmed air back to the freezer vault will convey the cold thermal energy out of the freezer vault and its associated mass. Upon completion of the cooling cycle the freezer's conventional refrigeration system must replace the cold thermal energy before a new cooling cycle commences.

Aspects of the disclosure may be found in an impingement cooling apparatus that utilizes additional thermal energy produced by a freezer refrigeration system when the temperature in the freezer vault rises. Freezer refrigeration systems increase in efficiency as the surrounding air temperature rises.

Other aspects of the disclosure may be found in an impingement cooling apparatus that stirs the food being cooled by raising and lowering one side of the holding container on a continuous or cyclic pattern. The movement forces the fluids in the food containers to move across the inside wall of the container adjacent to where the high velocity fluid is contacting the exterior surface. The thermal transfer is initiated through the container wall. The movement creates a flow of the fluid to be cooled throughout the container mixing the cooler outer portion with the warmer interior portions.

Still other aspects of the disclosure may be found in an impingement cooling apparatus that stirs the food being cooled by attaching vibration motors to the holding container which produces stirring of the fluid portions of the food in a similar manner as previously described.

Yet other aspects of the disclosure may be found in an impingement cooling apparatus that moves a cooling container and a thermal treatment device in relationship to each other allowing the columns of impingement air to form a path across the surfaces of the food container. This movement can be accomplished by several methods including a conveyor belt, mechanically moving the holding device or installing the vibrator motors on an angle and have them on a timed cycle to alternate the direction of vibration to move forward and backward.

Further aspects of the disclosure may be found in a cooling process that is monitored and reported to a central data device. The product to be cooled is monitored using a probe type thermometer to measure the internal temperature of the food. An input device captures the data from each probe showing the probe number with date, time, food product and operator, which allows tracking of the time and temperature from the beginning of the cooling cycle until the product has been removed from the device. The data stream from these product probes will be relayed on a real time basis to a computerized system that will recognize any errors in the cooling process. If the product does not cool to 70° F. in 2 hours time or to 41° F. in the next four hours an error report will be generated and an error message sent via phone or email to appropriate management personnel. The computerized system can be programmed to contain the menu for each serving period and the dates of service. If the food probes are not engaged at the appropriate time the system will produce an error message that is sent to a specified phone, email address or other device. The system will store and report the error on a compliance report.

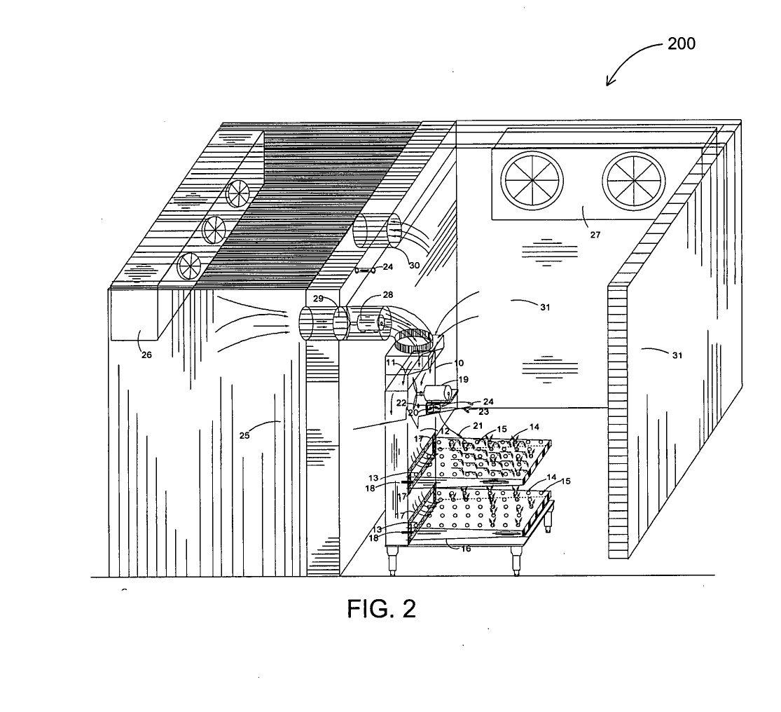

Referring to FIG. 2, a control system will monitor the temperature of the remote freezer or thermal storage system 25, the vault containing the thermal treatment apparatus 31, the air temperature being transferred from the remote storage area and the temperature of the air in the air duct 11 just before it enters the thermal treatment apparatus plenum. The control system will report these readings to a monitoring system for recording and reporting. The monitoring system will be set to notify appropriate management personnel if either of the vault temperatures rise above the set safety temperature and will shut down the thermal treatment process if the vault 31 temperature surrounding it rises above 41° F. The transfer fan will continue to run as long as the temperatures in the freezer or storage system are with the normal range and the refrigeration vault 31 is still above normal. The length of time the vault is above temperature will be logged by the computerized monitoring system.

Aspects of the disclosure may be found in an apparatus adapted to deliver a temperature-controlled gas from a chamber or vault containing thermally treated gas through a common plenum to at least two thermal treatment zones. The subject apparatus is adapted to direct columnated jets of a temperature-controlled gas so as to impinge on at least one surface of the food or other product placed in such zone. The apparatus is adapted to move either the product being cooled past the columns of air or the apparatus containing the columnating devices may move past the product being cooled. The device is further adapted to allow product to be moved in multiple zones or conveyed past multiple units. The apparatus is further adapted to provide stirring of fluids in the product being cooled. The apparatus further utilizes adjacent refrigeration systems to provide additional cooling as part of its refrigeration capacity and as a storage system that can provide peak demand cooling capacity.

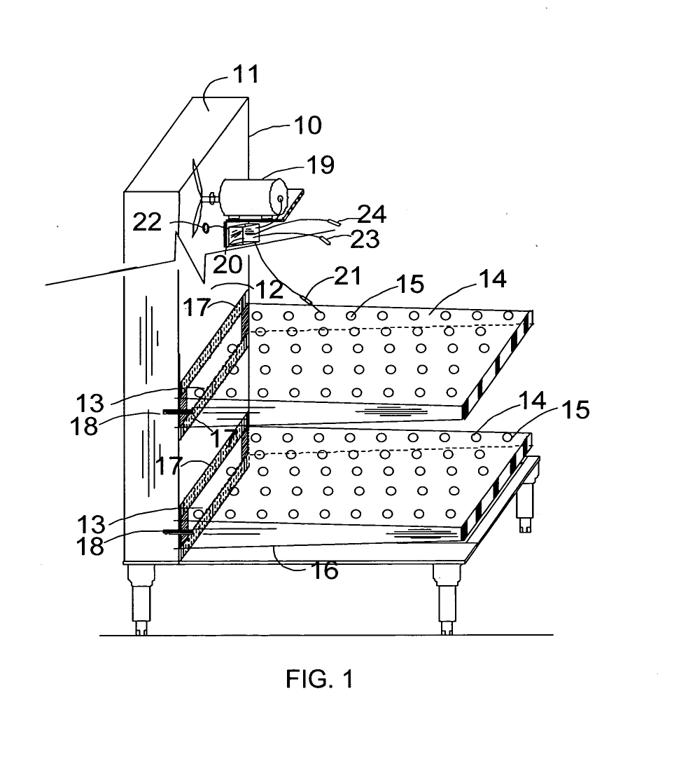

Referring to FIG. 1, a thermal treatment apparatus 10 according to the disclosure includes an air duct 11 with one end open for capturing thermally treated fluid. The air duct 11 consists of front, back, side and bottom walls fabricated of a sheet material such as stainless steel. In one embodiment of the disclosure, the front portion of the air duct 12 further comprises openings 13 which are used to attach a thermal treatment apparatus plenum 14. The thermal treatment apparatus plenum 14 consists of a tapered plenum with numerous orifices 15 placed in a pattern which provides nearly total coverage of high velocity impingement fluid across the product being cooled as the product or thermal treatment apparatus are moved relative to each other.

The thermal treatment apparatus plenum 14 preferably consists of two interlocking portions which are easily separated for cleaning and inspection. These two interlocking portions are constructed to provide uniform air distribution from each orifice 15. Each interlocking portion of the thermal treatment apparatus plenum 14 can contain orifices 15 or be solid where the system design does not require cooling fluid to be discharged in two directions. The portions of the thermal treatment apparatus plenums 14 which do not contain orifices 16 on both sides will be constructed with a different shape to provide consistent fluid flow through all of the other thermal treatment apparatus plenums. Outwardly extended flanges 17 are provided along the top, bottom, and sides to position and provide fluid seals.

Thermal treatment apparatus plenums 14 are held in place by the flanges and by a latching mechanism 18, which allows the thermal treatment apparatus to be removed.

The air duct 11 contains an air duct fan 19 to move the thermally treated fluid through the air duct and into the thermal treatment apparatus plenums 14 in such a manner as to produce a pre-determined fluid velocity through each of the orifices 15 located on one or more thermal treatment apparatus plenums 14. The fan 19 is controlled by a temperature monitoring and control system 20 that contain temperature monitoring product probes 21, fluid monitoring probes 22 for measuring the temperature of the treatment fluid, surrounding area fluid temperature monitor 23, remote freezer or thermal storage system temperature monitor 24 and a device to transfer data to a remote reporting and monitoring station. Surrounding area fluid temperature monitor 23 provides data to the temperature monitoring and control system 20 to insure that the surrounding air temperature does not rise above a determined limit of safe food storage.

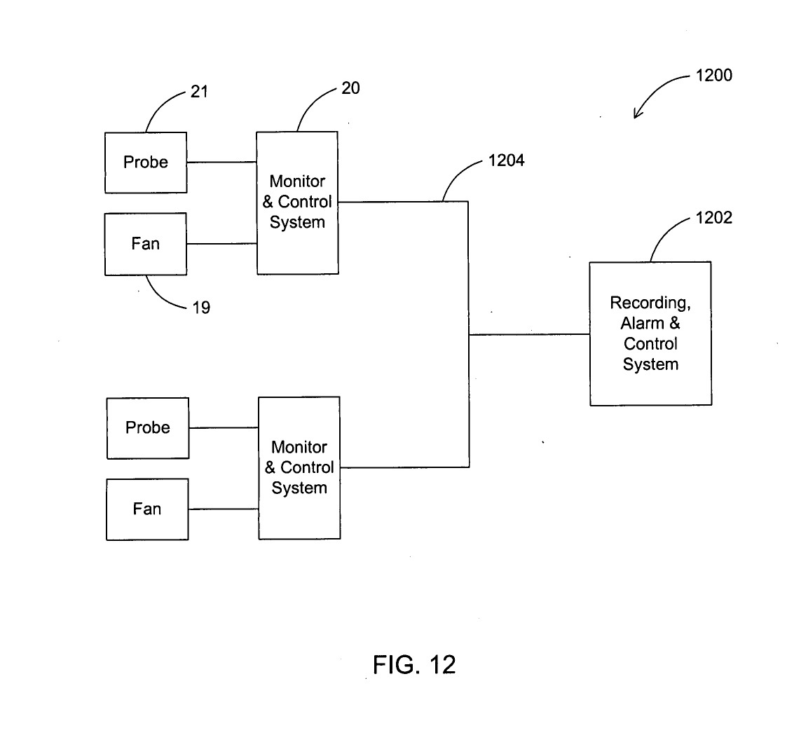

FIG. 12 depicts a schematic view of a monitoring system 1200 according to the disclosure. Monitoring devices 20 transmit data via communications link 1204 to a computerized record keeping and control system 1202. The system 1202 may send an alarm or other message via phone, email or other means when a temperature from one of the areas monitored by the monitoring devices 20 is above set limits or the cooling system does not meet the time temperature requirements. The system 1202 is also capable of shutting down the thermal treatment apparatus if the temperature in the refrigerated compartment 31 rises above 41° F. The controls may also set to regulate the fan speeds on a transfer fan 28 and the air duct fan 19 to regulate the mixed air temperature and maintain set temperate requirements in any of the vaults. An alternative monitor device may record and send a door open alarm when the vault doors are left open for more than a set time.

A further embodiment is that addition of temperature monitoring of hot food on food serving lines or storage cabinets with the ability to track the movement of the food pans into the thermal treatment apparatus. The tracking of a food pan from warming storage to serving station is a critical measurement providing data for hazard Analysis Critical Control Point (HACCAP) compliance. The monitoring process that begins at either hot food storage or at the beginning of serving provides data that the food was at the required hot temperature before service and that remaining portions were cooled in accordance with the Federal Guidelines

Referring to FIG. 2, an embodiment of the disclosure includes a remote freezer vault or thermal storage system 25 containing considerable cold mass that can function as both a food product holding vault and as a thermal storage system. The remote freezer vault or thermal storage system 25 has a refrigeration source 26 consisting of a compressor, evaporator and condenser system or cooled liquid such as CO² used to maintain and cool the remote freezer vault or thermal storage system 25. The remote freezer vault or thermal storage system 25 has a temperature monitor 24 which transmits the temperature of the remote freezer or thermal storage system to the temperature monitoring and control system 20.

The thermal treatment apparatus 10 is located inside a cabinet or vault 31 which contains a refrigeration source 27. When the thermal treatment apparatus was been activated the temperature monitoring and control system verifies that the temperature of the fluid in the remote freezer or thermal storage system 25 is within a preset temperature range for safe thermal transfer and activates the transfer fan 28 to deliver colder fluid from the remote freezer or thermal storage system 25 through a heated vent port 29 which is connected to air duct 11. The transfer fan has variable speed to enable the temperature monitoring and control system 20 to regulate the fluid temperature delivered to the thermal treatment apparatus by mixing the air from the remote freezer 25 with the air in the vault 31 surrounding the thermal treatment apparatus 10. Activation of the transfer fan 28 may cause the damper on the heated vent port 29 to open allowing the cold fluid to pass into the thermal treatment apparatus 10.

A return air heated vent port 30 is positioned at some distance from the thermal treatment apparatus 10 to provide a fluid flow from the warmer chamber 31 containing the thermal treatment apparatus 10 back to the remote freezer or thermal storage system 25. The damper on the heated vent port 30 may be activated by the positive pressure in the warmer chamber. The vent port between the freezer and the vault containing the thermal treatment apparatus 10 may be heated to prevent ice formation that would inhibit movement of the damper.

This circulation of colder fluid from the remote freezer or thermal storage system 25 to the thermal treatment apparatus 10 supplements the cooling capacity of the vault 31 containing the thermal treatment apparatus 10. The remote freezer or thermal storage system 25 will preferably have an operational temperature of 15 to 20 degrees below the requirement for safe frozen food storage.

This embodiment of the disclosure utilizes the combined refrigeration capacity of the refrigerated cabinet or vault 31, the refrigeration capacity of the remote freezer system 26 and the stored thermal energy of the remote freezer vault 25 and its contents as well that of the refrigeration vault and its contents. This combined thermal energy is moved from the freezer to the vault containing the thermal treatment apparatus by the transfer fan and air duct fan where it is mixed to prevent product freezing. The warmed air is them returned by the positive pressure to the freezer vault. When more energy is moved from the remote freezer vault than the refrigeration system can handle the temperature in the freezer vault 25 rises. The rise in temperature inside the vault 25 results in an increased capacity of conventional refrigeration systems 26. Therefore, the cooling capacity of the thermal treatment apparatus 10 is derived from both refrigeration systems, by the increased capacity of the conventional freezer refrigeration and the amount of stored thermal energy that can be transferred from the freezer vault.

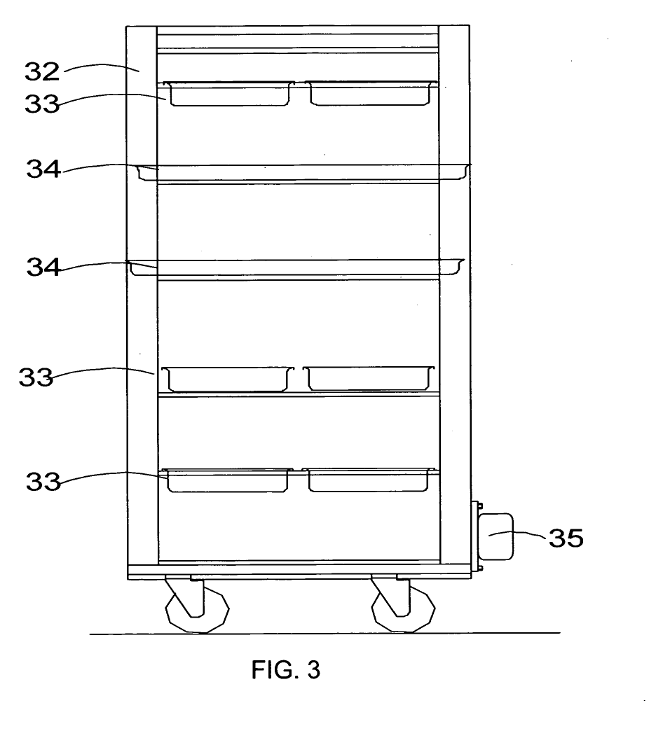

Referring to FIG. 3, another embodiment of the disclosure includes a product cart or stand 32 specifically designed to roll or be positioned in such a manner as that the product contained on the cart is positioned between the thermal treatment apparatus plenum 14 to allow the columns of high pressure air to impinge on the top and bottom surfaces of the product or product container. For retail food operations a product cart 32 may be designed with supports to hold standard 12″×20″ cafeteria pans 33, 18″×27″ bun pans 34, or other sized pans and flexible food bags. The cart construction is preferably stainless steel or aluminum construction in accordance with the National Sanitation Foundation guidelines. The cart or stand can be mounted on legs or on casters. The unit mounted on casters may have a vibration motor 35 mounted on such an angle that the cart will be moved forward when the motor is turning in one direction and backward when the motor turns in the opposite direction. The vibration motor force is designed to provide sufficient vibration of the cart and the fluids in the food containers to cause the fluids to mix the colder material located at the bottom, sides and top with the warmer fluid in the center thus increasing the rate of thermal transfer into the product.

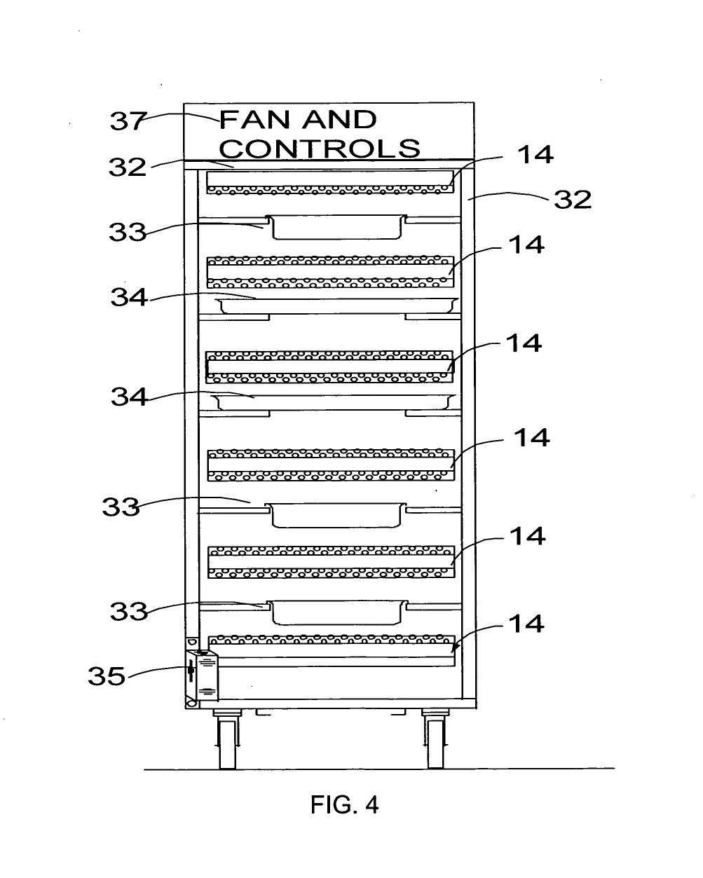

FIG. 4 shows a front elevation of the product cart 32 engaged with the thermal treatment apparatus 10 and the thermal treatment apparatus plenum 14 is shown between the product pans 33 and 34. The vibration motor 35 moves the cart forward and backward allowing the columnated air to sweep against different portions of the product thereby increasing the transfer of thermal energy. A fan and control module 37 houses the air duct fan motor 19, temperature monitoring and control system 20, vibration motor controls and connection points for the temperature monitoring product probes 21. The fan and control module 37 is mounted on the thermal treatment apparatus 10. The size of product cart 32 in this disclosure is variable to accommodate various different food cooling requirements.

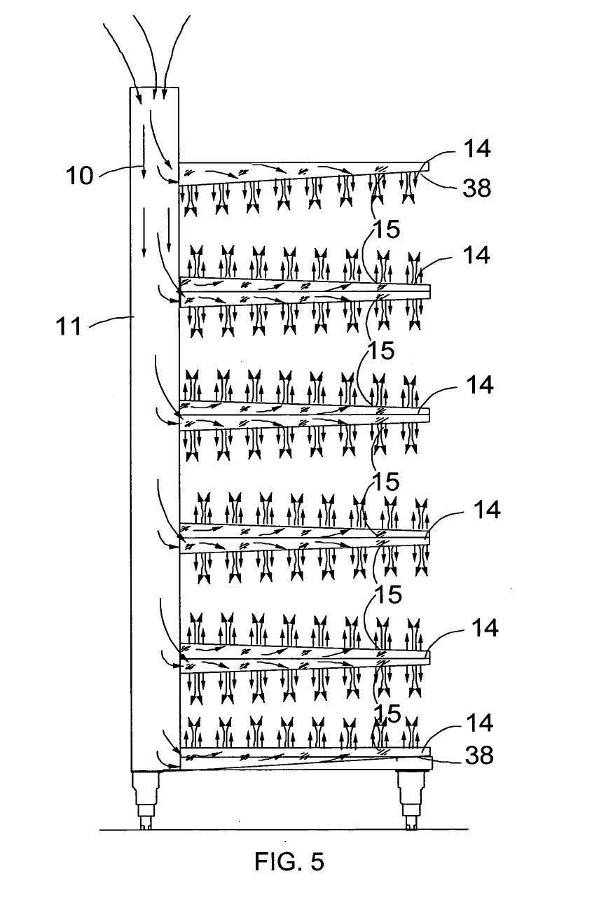

FIG. 5 shows a side elevation view of the thermal treatment apparatus 10 without the air duct fan 19 and fan and control module 37. The arrows indicate the flow of the air through the air duct 11 to the thermal treatment apparatus plenum 14 and out of the columnating orifices 15. The top and bottom thermal treatment apparatus plenums 38 extrude fluid in only one direction.

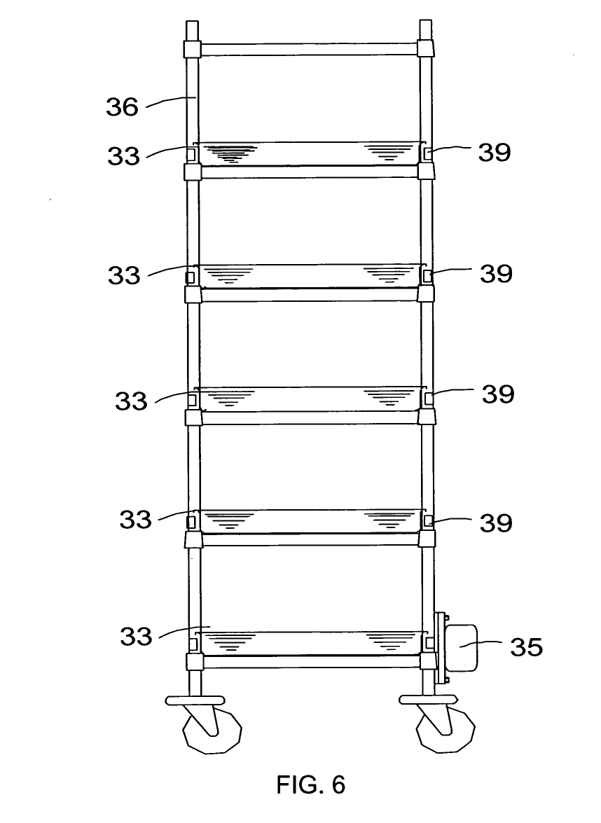

FIG. 6 shows a side elevation of food shelving unit 36 designed to be an industry standard mobile shelving unit modified by adding pan locks 39 along the length of the unit. The food shelving unit 36 is capable of holding products in many packaged forms including standard cafeteria pans 33, bun pans 34, and food packaged in casing bags. A vibrator motor 35 is attached at two locations on the food shelving unit depending upon the direction of travel required by the thermal treatment apparatus plenum. The size of food shelving unit 36 in this disclosure is variable to accommodate different food cooling requirements.

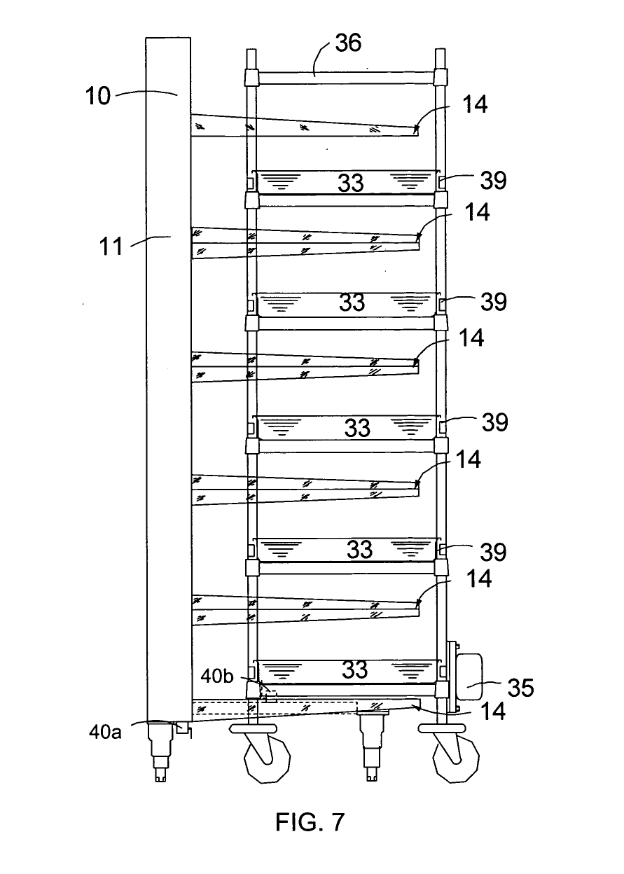

FIG. 7 shows a side elevation view of a thermal treatment apparatus 10 engaged with a mobile food shelf unit 36 in the most outward position. Travel limit switches 40a and 40b are installed on the thermal treatment apparatus and are used to stop the vibration and movement of the shelving unit or product cart 32 and reverse the direction of travel and vibration. During operation the vibration motor 35 propels the food shelf unit 36 closer to the air duct 11 of the thermal treatment apparatus 10 until the food shelf unit 36 contacts the travel limit switch 40a. The travel limit switch 40a stops the vibrator motor 35 and then turns it on in reverse rotation, which moves the shelf unit 36 away form the air duct 11 of the thermal treatment apparatus 10 until it contacts the outer travel limit switch 40b. The movement backwards and forwards directs the columns of treated air against additional surface areas of the food or product containers.

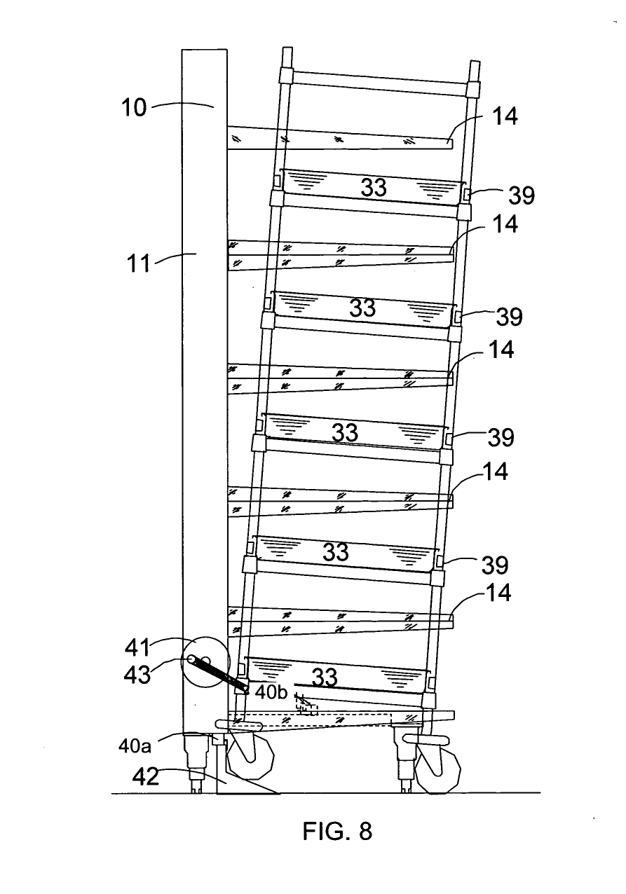

FIG. 8 shows a side elevation view of a thermal treatment apparatus 10 engaged with a mobile food shelf unit 36 in the most inward position. In this alternate embodiment the food shelf unit is cycled to and from the air duct 11 by the addition of a lifting wheel 41 and a tilt ramp 42. The tilt wheel includes a pin attachment to the propeller rod 43 which connect to the mobile shelf unit 36. When activated, the tilt wheel pulls the mobile shelf unit towards the air duct and at the same time helps lift it up the tilt ramp 42. Continued rotation of the wheel applies an outward force to the propeller rod 43 moving the food shelving unit away from the air duct 11 and controlling the rate of descent down the tilt ramp 42 of the food shelving unit 36. Lifting and lowering of the food shelving unit 36 causes the fluids in the containers to move back and forth in the containers helping to mixing the colder outer layer with the warmer inner area of the fluid.

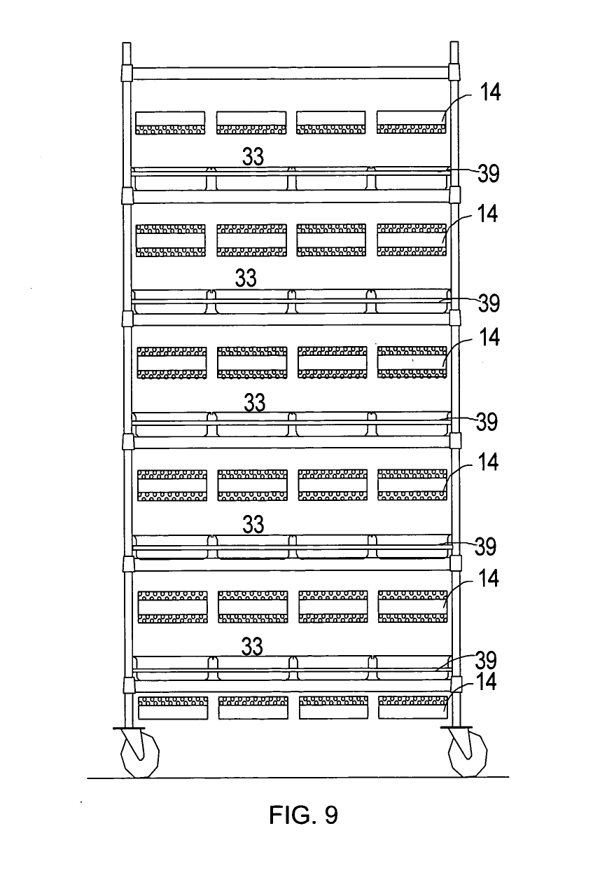

FIG. 9 shows a front elevation view of a mobile food shelf unit 36 with the end views of the thermal treatment apparatus plenum 14 positioned between the shelves holding the product to be cooled. The pan locks 39 are shown which insure the positioning of the pans 33 or packages of food and keep them from falling off the shelf when the rack is tilted.

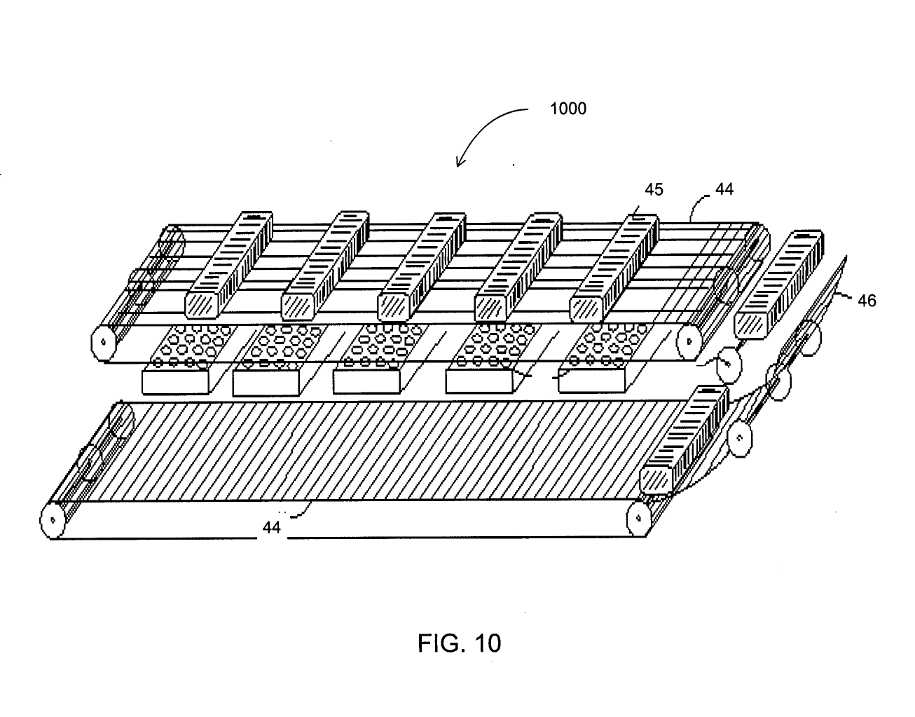

FIG. 10 shows an oblique view of a conveyor thermal treatment apparatus 1000 for cooling of packaged food in casings 45. The conveyor system 44 may include multiple conveyor sections stacked above each other and running in opposite directions. At the end of each section, a transfer device 46 designed to agitate the food casing tumbles the casings down a ramp to the next layer of the conveyor. The second conveyor runs in the opposite direction and at the end tumbles the bags to a subsequent layer. The tumbling provides the stirring action within the bag to improve the cooling rate.

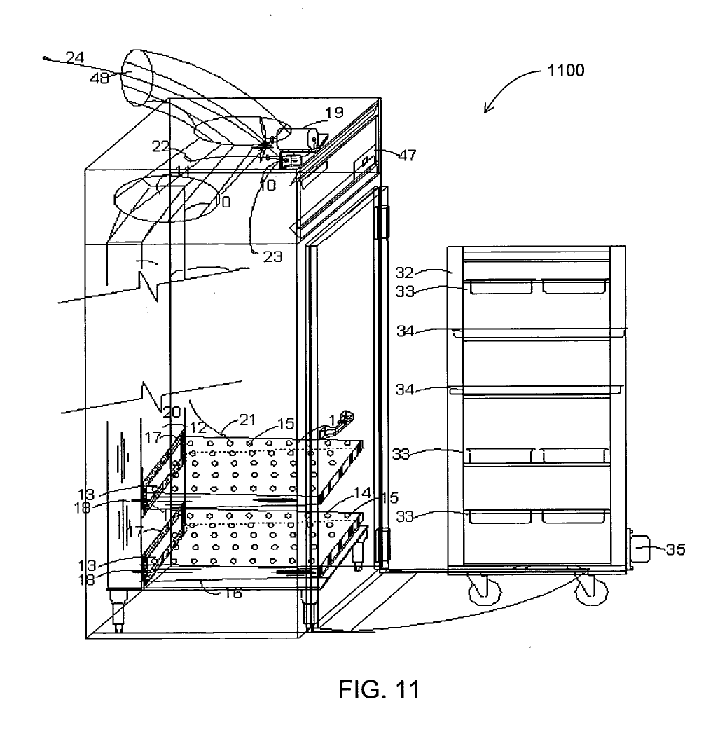

FIG. 11 shows an oblique view of a thermal treatment apparatus 1100 built into a cabinet style refrigerated box 47 such as a typical reach-in or roll-in refrigeration boxes. Cold air is conducted by a duct 48 from an external cold thermal energy source. An alternate configuration is to install an evaporator coil inside the air duct 11 and utilize the fan 19 to function as both the evaporator fan and the fan to move the air through the thermal treatment apparatus plenum 14. A remote refrigeration, brine or ice water bath may serve as the source of cold thermal energy.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. A method of cooling food product containers to a predetermined temperature, the method comprising:
drawing air from a first area where food products are kept at a temperature below the predetermined temperature into a second area, wherein the second area is separated from the first area;
pushing the air into a plurality of plenums having orifices, wherein the plenums are interleaved with a corresponding plurality of food product containers in the second area and the air discharged through the orifices impinges on the food product containers; and
returning air from the second area to the first area.

2. The method of claim 1, wherein the second area is a cooler and the first area is a freezer.

3. The method of claim 1, further comprising:
monitoring a temperature of at least one of the food product containers,
wherein pushing the air into a plurality of plenums is performed according to the monitored temperature.

4. The method of claim 1, further comprising:
monitoring a temperature of at least one of the food product containers; and
sending a message when the monitored temperature meets a predetermined criteria.

5. The method of claim 1, further comprising:
monitoring a temperature of at least one of the food product containers; and
preparing a report comprising a plurality of values of the monitored temperature at a corresponding predetermined plurality of times.

6. The method of claim 1, wherein the food storage containers are supported by a structure, the method further comprising:
moving the structure to cause circulation of a liquid in the food storage containers.

7. The method of claim 6, wherein the food storage containers are supported by a plurality of conveyor belts interleaved with the plurality of plenums.

8. A cooling apparatus for cooling food product containers to a predetermined temperature, the cooling apparatus comprising:
a thermal treatment apparatus, comprising:
an air duct, adapted to receive air from a first area where food products are kept at a temperature below the predetermined temperature;
a plurality of plenums having orifices, the plenums coupled to the air duct; and
a fan, adapted to push air received from the first area into the plurality of plenums; and
a container support apparatus, comprising:
a plurality of container supports adapted to support food product containers and positioned to interleave the food product containers with the plurality of plenums,
wherein air discharged through the orifices impinges on food product containers supported by the container support apparatus.

9. The cooling apparatus of claim 8, wherein the food container support apparatus is adapted to move away from the thermal treatment apparatus for loading of food product containers.

10. The cooling apparatus of claim 8, further comprising:
a controller coupled to the fan and to a probe operable to monitor a temperature of at least one of the food product containers,
wherein the controller is adapted to control the fan according to the monitored temperature.

11. The cooling apparatus of claim 8, further comprising:
a controller coupled to a probe operable to monitor a temperature of at least one of the food product containers,
wherein the controller is adapted to send a message when the monitored temperature meets a predetermined criteria.

12. The cooling apparatus of claim 8, further comprising:
a controller coupled to a probe operable to monitor a temperature of at least one of the food product containers,
wherein the controller is adapted to prepare a report comprising a plurality of values of the monitored temperature at a corresponding predetermined plurality of times.

13. The cooling apparatus of claim 8, further comprising:
a motor, adapted to move the container support apparatus to cause circulation of a liquid in the food storage containers.

14. The cooling apparatus of claim 8, wherein the plurality of container supports comprises a plurality of conveyor belts.

15. A system for cooling food product containers to a predetermined temperature, the system comprising:
a first enclosed area where food products are kept at a temperature below the predetermined temperature;
a second enclosed area, separate from the first enclosed area;
a thermal treatment apparatus located in the second enclosed area, comprising:
an air duct, adapted to receive air from the first enclosed area;
a plurality of plenums having orifices, the plenums coupled to the air duct; and
a fan, adapted to push air received from the first enclosed area into the plurality of plenums;
a container support apparatus located in the second enclosed area, comprising:
a plurality of container supports adapted to support food product containers and positioned to interleave the food product containers with the plurality of plenums
wherein air discharged through the orifices impinges on food product containers supported by the container support apparatus.

16. The system of claim 15, further comprising:
a controller coupled to the fan and to a probe operable to monitor a temperature of at least one of the food product containers,
wherein the controller is adapted to control the fan according to the monitored temperature.

17. The system of claim 15, further comprising:
a controller coupled to a probe operable to monitor a temperature of at least one of the food product containers,
wherein the controller is adapted to send a message when the monitored temperature meets a predetermined criteria.

18. The system of claim 15, further comprising:
a controller coupled to a probe operable to monitor a temperature of at least one of the food product containers,
wherein the controller is adapted to prepare a report comprising a plurality of values of the monitored temperature at a corresponding predetermined plurality of times.

19. The system of claim 15, further comprising:
a motor, adapted to move the food container support apparatus to cause circulation of a liquid in the food storage containers.

20. The system of claim 15, wherein the plurality of container supports comprises a plurality of conveyor belts.

21. A cooling apparatus for cooling food product containers to a predetermined temperature, the cooling apparatus comprising:
a source of air at a temperature below the predetermined temperature;
a thermal treatment apparatus, comprising:
a plurality of plenums having orifices; and
a fan, adapted to push air from the source of air into the plurality of plenums;
a container support apparatus, comprising:
a plurality of container supports adapted to support food product containers and positioned to interleave the food product containers with the plurality of plenums; and
a motor, adapted to move the container support apparatus to cause circulation of a liquid in the food storage containers.
wherein air discharged through the orifices impinges on food product containers supported by the container support apparatus.

22. The cooling apparatus of claim 21, wherein the motor moves the container support apparatus between first and second positions, wherein the air discharged through the orifices impinges on a first portion of a surface of the food product containers in the first position and one a second portion of the surface of the food product containers in the second position.

23. The cooling apparatus of claim 21, wherein the motor moves the container support apparatus in a reciprocating motion between first and second positions.
